(19) United States
(12) Patent Application Publication
(10) Pub. No.: US 2011/0037879 A1
(43) Pub. Date: Feb. 17, 2011

(54) ZOOM CAMERA MODULE

(76) Inventor: Youngman KWON, Seoul (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/854,471

(22) Filed: Aug. 11, 2010

(30) Foreign Application Priority Data
Aug. 11, 2009 (KR) 10-2009-0073716

(51) Int. Cl. H04N 5/262

(52) U.S. Cl. 348/240.3; 348/E05.055

(57) ABSTRACT

Disclosed herein is a zoom camera module, the zoom camera module concluding an optic zoom lens part which includes a plurality of lenses and alters the disposition of the plurality of lenses for change to the magnification, and an imaging sensor which converts light transmitted through the optic zoom lens part into an electric signal, the disclosed zoom camera module controlling the focus of a subject using an EDOF (Extended Depth of Field) technology.

### CROSS-REFERENCE TO RELATED APPLICATION

This application claims the benefit under 35 U.S.C. §119 of Korean Patent Application No. 10-2009-0073716, filed on Aug. 11, 2009, which is hereby incorporated by reference in its entirety.

### BACKGROUND

1. Field of the Invention

The present invention relates to a zoom camera module.

2. Description of the Related Art

In order to add a digital camera function to small-size electronic appliances such as a cell phone and a PDA, a multiple of camera module-mounted products has come out recently on the market. And, there has been a continuing effort in the function-supplemented digital camera module to secure the performance of an all but identical level to a general digital camera.

With an aim to secure performance coming near to a general digital camera, rising interest in a lens driving technology for implementing a zoom function or a close-up function as well as in an image resolution raising technology is on the increase. However, it is inevitably limited by the fact that a camera module installed in a small-sized electronic appliance is smaller in its dimension than that of a general digital camera, so that there are many spatial constraints on realizing an optical zoom function like a general digital camera and thus a zoom in the software manner used to expand images formed on a CCD (Charge Coupled Device) or a CMOS (Complementary MOS) imaging device is much in use. Because the software mode zoom needs to expand an image formed on the imaging device by using a program and therefore there is a drawback of the resolution drop, an optical zoom function must be adopted to obtain a better image.

Therefore, several optical appliances such as a camera, a camcorder, a compact zoom camera, a surveillance camera and a micro-aerial vehicle has a structure adapted to forward/backward a lens for the zoom function. Such an optical zoom-use lens module renders the overall size of a camera module to be larger and reduces the freedom for camera modules to be employed for a use in a portable telephone.

### BRIEF SUMMARY

The present invention provides a camera module in which an entire number of lenses on an optical system is reduced and spatial limits in realizing an optical zoom function are not suffered.

A zoom camera module according to one embodiment of the present invention comprises: an optical zoom lens part including a plurality of lenses and for altering the disposition of the plurality of lenses for change in magnification; and an image sensor converting light transmitted through the optical zoom lens part into an electric signal, wherein the zoom camera module controls the focus of a subject using EDOF (Extended Depth of Field) technology.

In realizing a zoom camera module, the number of the entire lenses in an optical system is reduced. In a moving image recording, a focus control towards the lens movement according to a distance to the object is not necessary and an optical zoom realization can be made only by zooming.

### BRIEF DESCRIPTION OF THE DRAWINGS

FIG. 1 is a diagram showing the drive of an optical zoom lens part;

FIG. 2 is a diagram briefly indicating a camera module having an auto focus control function; and

FIG. 3 is a diagram showing the drive of an optical zoom lens part according to the present embodiment.

### DETAILED DESCRIPTION

Since it is possible that various changes are made to the present invention and various kinds of embodiments are implemented, specific embodiments will be illustrated in the drawings and intended to be described in the detailed description in detail. However, it should not be appreciated in a limiting sense of limiting the present invention to a specific practice but to include all the changes, equivalents and replacements which fall in the spirit and technological scope of the present invention.

Terms including an ordinal number such as the first and the second can be used in describing various components, and however, such components are not limited to the terms. The terms are only used for the purpose of distinguishing from one component to another component. For example, without deviating from the scope of the present invention, a second component may be named as a first component, and similarly a first component also may be named as a second component.

Stated that any component “is connected” or “is conjunctive” to another component, it would be appreciated to be directly connected or conjunctive to the very another component or that there exists the other component in the midst of them.

In the following, a preferred embodiment according to the present invention will be described in detail with reference to the attached drawings, but independent of drawing signs an identical or corresponding component is assigned the same reference numeral and a redundant description of this will be omitted.

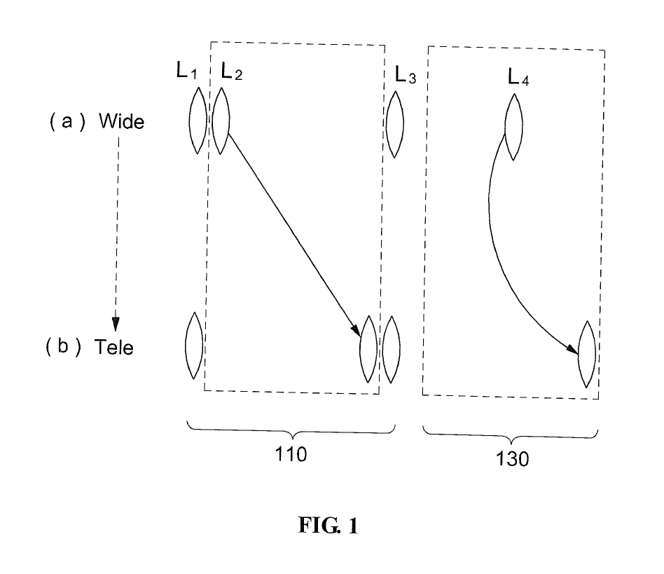

FIG. 1 is a diagram showing the drive of an optical zoom lens part.

This figure is a diagram briefly depicting the construction of a zoom lens comprised of a lens group of previous 4 groups. FIG. 1(a) is the appearance of a zoom lens in the wide end, and FIG. 1(b) is the appearance of a zoom lens in the tele end.

Referring to FIG. 1, the optical zoom lens part is comprised of a first lens L1, a second lens L2, a third lens L3, and a fourth lens L4. The optical zoom lens part 110 includes a zoom part 110 and a focus control part 130, and the zoom part 110 requires a zooming lens group for changing the magnification and a compensator lens group for fixing the position of an image plane altered according to the movement of the zooming lens group.

In FIG. 1, the zooming lens part changing the magnification is the second lens L2, and the second lens L2 moves to alter the magnification of a zoom lens. In FIG. 1(a), for a wide end, the second lens L2 is placed adjacent to the first lens L1 as seen from the figure, and in FIG. 1(b), for a tele end, the second lens L2 is placed adjacent to the third lens L3 as seen from the figure. The compensator lens group consists of the first lens L1 and the third lens L3.

The focus control part 130 is the fourth lens L4, having a structure in which a lens moves towards an arrow direction. Lens's motion trajectory for embodying this is greatly constricted by the optical magnification and the movements of a motor through an optic calculation. Also, two motors each for the zoom part 110 and the focus control part 130 are necessary, and to do this, a piezo motor or a stepping motor can be used.

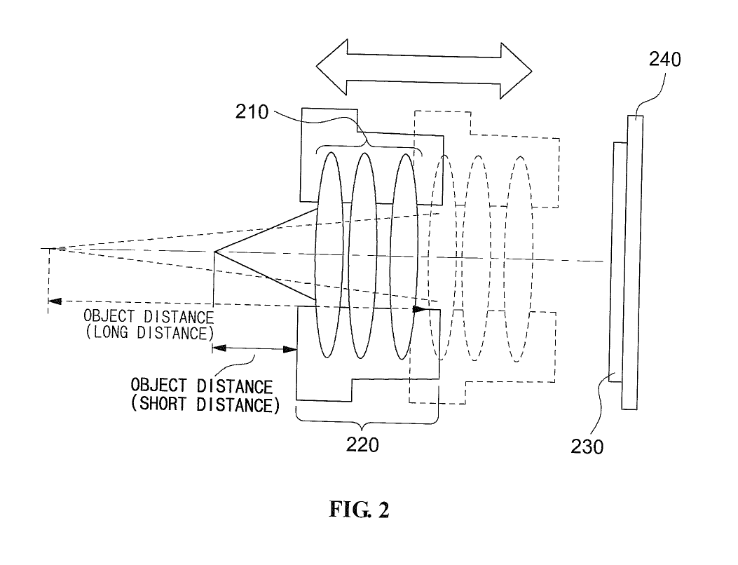

FIG. 2 is a diagram briefly indicating a camera module having an auto focus control function.

Referring to FIG. 2, a lens part 210 including a multiple of lenses is inserted into a barrel 220 so the lens part 210 is protected by the barrel 220, and such a barrel 220 is connected to a VCM (Voice Coil Motor) or a piezo motor, etc. to change the image plane position according to an object distance to control a focus point through the movement of the lens part 210. Optic images passed through the lens part 210 are, in the imaging sensor 230, converted into an electric signal, and on the back surface of the image sensor 230, a printed circuit board 240 is attached by an adhesive such as epoxy.

In recent years, the auto focus control function can be performed through an image processing using EDOF (Extended Depth of Field) technology that expands depth of field of a camera module, differently from the shown FIG. 2 and that is, without the movement of a lens. When using an EDOF (Extended Depth of Field) technology, the focus-controlled images of a short distance object and a long distance object all can be obtained on one screen in real-time.

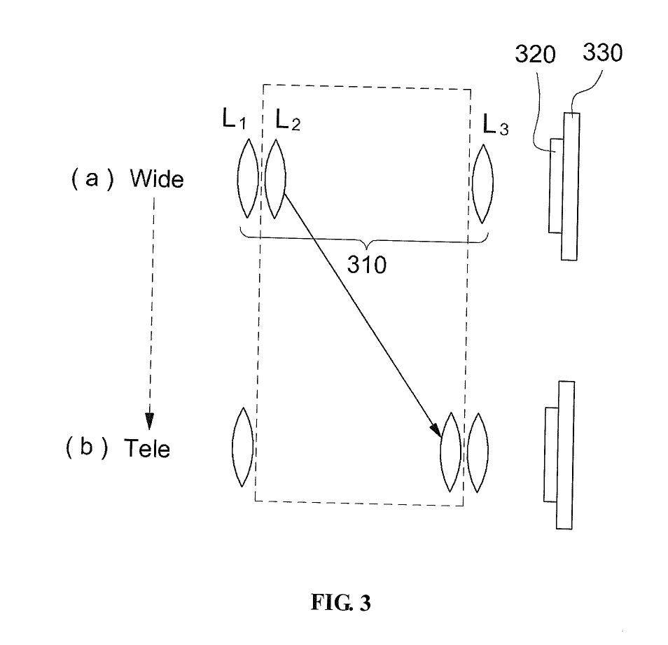

FIG. 3 is a diagram showing the drive of an optic zoom lens part according to the present embodiment. FIG. 3(a) is the appearance of a zoom lens in the wide end, and FIG. 3(b) is the appearance of a zoom lens in the tele end.

Referring to FIG. 3, the optic zoom lens part 310 is comprised of a first lens L1, a second lens L2 and a third lens L3, and a lens for changing magnification is the second lens L2, changing the magnification of the zoom lens as the second lens L2 moves and the position of the second lens L2 in the wide end and the tele end is the same as FIG. 1. Such an optic zoom lens part 310 may shift a lens using a piezo motor or a stepping motor.

It would be obvious by those skilled in the art that the lens number of the optic zoom lens part 310 can be varied in addition to the aforementioned embodiment. The imaging sensor 320 converts light transmitted through the optic zoom lens part 310 into an electric signal. On the back surface of the imaging sensor 320, by an adhesive such as epoxy a printed circuit board 330 is attached. Also, an ISP (Image Signal Process) (not shown) can convert the electric signal so as to control the focus point of a subject by the EDOF technology through an image processing.

In the present embodiment, the auto focus control function may be performed using the EDOF (Extended Depth of Field) technology. Through EDOF (Extended Depth of Field) technology, real-time focus controlled images of a short range object and a long range object both may be obtained on one screen. Herein, EDOF technology may use various methods, such as a method of designing an appropriable optic system having the extended depth of focus, a method of constantly keeping the response of a camera module obtained from a sensor surface independent of a subject's distance by attaching a special optic phase mask to the lens, and a method of compensating pixel values. Preferably, a focus is controlled by performing EDOF technology through the image processing of an ISP (Image Signal Process) (not shown).

Therefore, the present embodiment may downsize the camera module's size to the longitudinal direction, and may obtain focus-controlled images of all short distance objects and long distance objects in real-time over the entire region without a need to move a lens to control an auto focus for each object's distance in real-time.

All the above-mentioned functions can be performed by processors such as a microprocessor, a controller, a microcontroller, and ASIC (Application Specific Integrated Circuit) according to coded software or a program code, etc. for carrying out such a function. The design, development and embodiment of the code would be obvious to those skilled in the art based on the description of the present invention.

While the embodiments of the present invention has been explained in detail at the foregoing part, the rights scope of the present invention is not limited to the embodiment and various modifications and substitutions thereto by those skilled in the art using the basic concept of the present invention as defined in the accompanying claims will fall under the scope of the invention.

What is claimed is:

1. A zoom camera module, including;
an optic zoom lens part including a plurality of lenses for altering a disposition of a plurality of lenses for changes in the magnification; and
an imaging sensor converting light transmitted through the optic zoom lens part into an electric signal,
wherein the zoom camera module controls the focus of a subject using an EDOF(Extended Depth of Field) technology.

2. The zoom camera module as claimed in claim 1, further including an image signal processor converting the electric signal into a subject focus controlled image using the EDOF (Extended Depth of Field) technology.

3. The zoom camera module as claimed in claim 2, wherein the conversion into the subject focus controlled image is performed through a compensation of pixel images.

4. The zoom camera module as claimed in claim 1, wherein an optical phase mask for using the EDOF (Extended Depth of Field) technology is attached to at least one lens of the optic zoom lens part.

5. The zoom camera module as claimed in claim 1,
wherein the plurality of lenses includes at least a first lens, a second lens and a third lens disposed sequentially from an object side, and
wherein in order to change the magnification of the optic zoom lens part, the second lens is placed adjacent to the first lens for a wide end and the second lens is placed adjacent to the third lens for a tele end.

6. The zoom camera module as claimed in claim 1, wherein the disposition of the plurality of lenses is altered using a piezo motor or a stepping motor.
